(19) United States
(12) Patent Application Publication
(10) Pub. No.: US 2023/0249011 A1
(43) Pub. Date: Aug. 10, 2023

(54) Mask With Sensor

(71) Applicant: PENTATONIC LIMITED, London (GB)

(72) Inventor: Volodymyr NESIN, London (GB)

(21) Appl. No.: 18/016,590

(22) PCT Filed: Jul. 13, 2021
(86) PCT No.: PCT/GB2021/051791

§ 371 Date: Jan. 17, 2023

(30) Foreign Application Priority Data
Jul. 15, 2020 (US) 63052114

(51) Int. Cl. A62B 18/08; A62B 18/02; A62B 9/00; A41D 13/11

(52) U.S. Cl. CPC A62B 18/08; A62B 18/025; A62B 9/006; A41D 13/11

(57) ABSTRACT

There is provided a mask for wearing on the face of a user. The mask comprises a mask body, a filter connected to the mask body, an electrical power source, and a control system. The mask further comprises a gas sensor configured to measure properties of a gas, such as a user's breath and/or ambient air.

### RELATED APPLICATIONS

This application claims the benefit of priority under PCT Article 8 of PCT application PCT/GB2021/051791, filed on Jul. 13, 2021, which claims priority to U.S. Provisional Patent Application No. 63/052,114 filed on Jul. 15, 2020, the contents of which are incorporated herein by reference in their entirety.

### FIELD

The present teachings relate to a mask for wearing over a face of a user.

### BACKGROUND

The prevention of viral and microbial transmission is a huge societal problem, as illustrated by the Covid-19 pandemic that began in 2020. As such, the global demand for face coverings (such as doth, surgical, and FFP respirators) as a precautionary measure to suppress transmission has surged. Wearable masks are becoming more popular for use in public to prevent diseases and protect the user from potential viruses, bacteria or air pollution.

Single-use surgical masks, which are arguably the most prevalent in society today, are primarily composed of synthetic, woven polymeric materials. This type of mask cannot be recycled, and may even break down into micro or nanoplastics, which are particularly concerning pollutants. More recently, electronic masks have increased in use. However, existing electronic masks are limited in their use.

The present teachings seek to overcome or at least mitigate one or more problems associated with the prior art.

### SUMMARY

A first aspect of the teachings provides a mask for wearing over a face of a user, the mask comprising: a mask body; a filter connected to the mask body; an electrical power source; a control system; a user interface in communication with the control system; and a sensor assembly comprising a first sensor, wherein the first sensor is configured to measure properties of a gas, e.g. ambient air and/or expiratory gases of a user, and to provide an output to the control system based on the measured gas properties.

The mask may comprise a locked state in which the first sensor is inactive and an unlocked state in which the first sensor is active so as to measure properties of a gas.

In this way, the mask only measures a quality of gas when the mask is in an unlocked state, thereby saving power.

The control system may be configured to move the mask from the locked state to the unlocked state based upon a user input detected by the user interface.

In this way, it is ensured that the mask only transitions to the unlocked state when intended by the user, minimising the risk of wasting power.

The control system may be configured to move the mask from the locked state to the unlocked state only when the user input corresponds to an activation pattern.

In this way, the mask is prevented from entering the unlocked state unless the input from the user corresponds to the activation pattern, thereby further reducing the risk of wasting power.

The user interface may be a touch-sensitive user interface and the pre-defined activation pattern may be a double-tap on the touch-sensitive user interface.

The control system may be configured to prevent movement from the locked state to the unlocked state upon a determination that the input does not correspond to the activation pattern.

The mask may comprise a memory, and wherein the activation pattern is a pre-defined activation pattern stored in the memory.

The sensor assembly may comprise a second sensor configured to detect movement of the mask, and wherein the control system is configured to move from the locked state to the unlocked state only when movement of the mask is detected.

The control system may be configured to move from the locked state to the unlocked state only when a user input detected by the interface corresponds to an activation pattern after movement of the mask has been detected.

The mask may comprise an indicator configured to indicate movement of the mask from the locked state to the unlocked state.

The mask may comprise a memory, wherein the output of the first sensor, corresponding to measured gas properties, is stored in the memory.

In this way, a log of historical gas quality data can be stored for future analysis.

The mask may be configured to transmit, e.g. via wired or wireless connection, the measured gas properties stored in the memory to an external electronic device for analysis.

Transmission of the data in this way means that processing of the gas properties data is done remote from the mask, thus reducing the energy consumption of the mask, thus extending the battery life.

The mask may be configured to communicate with the external electronic device via an RF module to transmit the measurements of the gas properties stored in the memory to an external electronic device.

The mask may be configured to pair with an external electronic device via an RF module and transmit the measurements of the gas properties stored in the memory to an external electronic device for analysis.

The mask may comprise an indicator configured to be activated based on a signal received from an external electronic device, e.g. via an RF module, for notifying the user of a harmful scenario detected by the external electronic device.

In this way, the mask is able to alter a user to a potential health issue detected by the external electronic device based on the measured properties of the gas.

The mask may be configured to transmit, e.g. via wired or wireless connection, the measured gas properties stored in the memory to an external electronic device periodically.

Transmission of the data in this way has been found to reduce energy consumption of the mask, thus extending the battery life.

The first sensor may be configured to measure the composition of the gas and/or the humidity of the gas.

The sensor assembly may be configured to measure the gas properties periodically, for example every minute.

Each measurement may be recorded for a pre-determined length of time, for example for continuous intervals in the range 5 to 10 seconds.

The mask may be configured to measure gas concentration/composition via the first sensor; gas humidity via the first sensor; and temperature via a temperature sensor.

The mask may be configured to detect concentrations of one or more of: acetoacetate; beta-hydroxybuterate; acetone; methane; carbon monoxide; iso-butane; hydrogen and/or ethanol in the gas.

The first sensor may be configured to measure the properties of the gas for detecting keton levels in the expiratory gases of a user.

Keton levels can be measured in expiratory gases (i.e. the breath) of a user. The mask is configured to measure these keton levels in the expiratory gas. Keton levels are generally between 0.5 and 3.0 millimomar (mM) in physiologic ketosis. In ketoacidosis, however, keton levels in expiratory gases (i.e. the breath) of a user may be present in concentrations greater than 10 mM. Thus, through the detection of a user's keton breath levels, a range of potential illnesses may be detected.

The sensor assembly may comprise a measuring circuit comprising a sensing element and a load resistor of a predetermined resistance in series with the sensing element, and wherein the properties of the gas are determined based on a resistance of the sensing element.

The control system may be configured to determine gas composition and humidity based on gas concentration sensitivity characteristics and humidity sensitivity characteristics of the sensing element, respectively.

The control system may be configured to determine the resistance of the sensing element based on a measured voltage drop across the load resistor.

The sensor assembly may comprise a third sensor configured to determine ambient temperature.

The mask may comprise a heater configured to heat the first sensor to a predetermined temperature.

The heater maintains the sensing element at a specific predetermined temperature that is optimal for sensing.

According to a second embodiment, there is provided a system comprising: a mask according to the first aspect; and an electronic device, wherein the mask is configured to generate a sensor output signal to the control system in response to measured gas properties and to store data corresponding to the measured gas properties in a memory of the mask, wherein the mask is configured to transmit the data to the external electronic device, and wherein the external electronic device is configured to analyse the data using a machine learning algorithm to determine if there is a harmful scenario.

The mask may comprise an indicator configured to be activated based on an output signal received from the external electronic device, when a harmful scenario has been determined by the external electronic device.

According to a third aspect, there is provided a method of measuring a gas using a mask according to the first aspect, the method comprising the steps of: measuring properties of a gas via the first sensor; generating a sensor output signal to the control system in response to measured gas properties; storing data corresponding to the measured gas properties in a memory of the mask; transmitting the data to an external electronic device; analysing the data on the external electronic device using a machine learning algorithm to determine if there is a harmful scenario.

The method may comprise the step of providing an output signal from the external electronic device to the mask, when a harmful scenario has been determined by the external electronic device, so as to activate an indicator of the mark for providing an alert or alarm to a user that a harmful scenario has been determined.

### BRIEF DESCRIPTION OF THE DRAWINGS

Embodiments will now be described with reference to the accompanying drawings, in which:

FIG. 1 is a view of a mask according to an embodiment;

FIG. 2 is an enlarged partial view of the mask of FIG. 1;

FIG. 3 is a block diagram showing an example component architecture of the mask of FIG. 1;

FIG. 4 is a control logic diagram of the mask of FIG. 1 for moving from a locked state to an unlocked state;

FIG. 5 is a further control logic diagram of the mask of FIG. 1 for moving from a locked state to an unlocked state;

FIG. 6 is a further control logic diagram of the mask of FIG. 1 for moving from a locked state to an unlocked state; and

FIG. 7 is a schematic gas measuring circuit of the mask of FIG. 1.

### DETAILED DESCRIPTION OF EMBODIMENT(S)

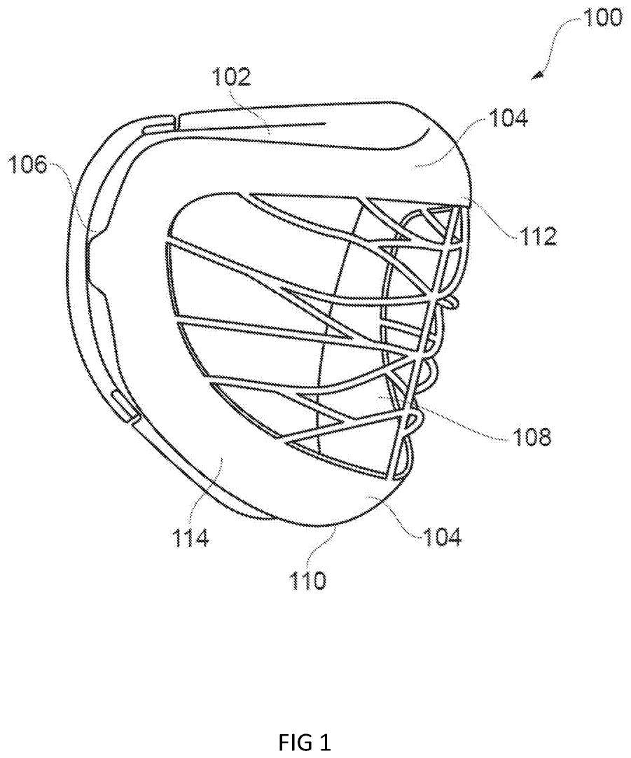

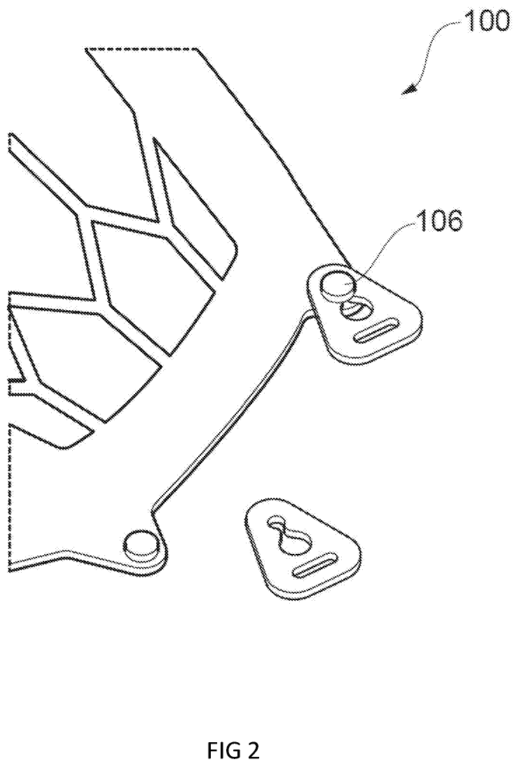

Referring firstly to FIGS. 1 and 2, a wearable mask is illustrated and is indicated generally at 100. The mask has a mask body 102. The mask 100 includes a filter (not shown) connected to the mask body 102. The mask includes a sensor assembly including one or more sensors 104. In the illustrated arrangement, the one or more sensors 104 are located proximate to the top and bottom of mask body 102.

The one or more sensors 104 include a first sensor configured to measure properties of a gas (i.e. a gas sensor). It will be understood that the gas may be ambient air and/or expiratory gases of a user. The first sensor is configured to provide an output to a control system (not shown) based on the measured gas properties. The first sensor, i.e. the gas sensor, may be used to determine the quality of air in proximity of the mask 100. The first sensor is configured to measure the composition of the gas and/or the humidity of the gas. The one or more sensors 104 may include a second sensor configured to detect movement of the mask 100 (i.e. a movement/vibration sensor). The one or more sensors 104 may include a third sensor configured to determine ambient temperature (i.e. a temperature sensor). The mask has a user interface 106. In the example shown, the user interface 106 is a touch-sensitive user interface. The touch-sensitive user interface 106 is in communication with the control system.

The mask 100 has a first, locked, state in which the first sensor is inactive. The mask has a second, unlocked, state in which the first sensor is active so as to measure properties of a gas. The control system is configured to move the mask 100 from the locked state to the unlocked state based upon a user input detected by the user interface 106. The user interface 106 is configured to receive an input, e.g. a touch input, from the user. As is illustrated in FIG. 2, the user interface 106 is located proximate a lateral edge of the mark 100.

The mask 100 includes an electrical source of power in the form of one or more batteries 110. It will be appreciated that any electrical source of power capable of supplying electrical power to the mask may be suitable. The mask 100 includes circuitry 108 configured to connect the various components of the mask to the batteries 110.

The mask 100 includes an indicator 112 configured to alert a user that wearable mask 100 is transitioning from the locked state to the unlocked state. In the arrangement shown, the mask 100 includes an indicator in the form of one or more vibration modules 112, which are configured to vibrate to alert a user that wearable mask 100 is transitioning from the locked state to the unlocked state. In alternative arrangements, the skilled person would appreciate that other alternative modules would be suitable for alerting the user of a change in mask status, such as a visual (e.g. light) module and/or an audio (e.g. sound-emitting) module.

The mask 100 is configured to transmit, e.g. via wired or wireless connection, the measurements of the gas properties stored in a memory to an external electronic device (not shown). The mask 100 includes one or more radio-frequency (RF) modules 114 configured to communicate with an external device to transmit the measurements of the gas properties to an external electronic device. The mask 100 is configured to pair with an external electronic device via the RF module 114 and transmit the measured gas properties to the external electronic device. It will be appreciated that the mask 100 may be configured to transmit to the external electronic device at predetermined time intervals. It will be appreciated by the skilled person that any suitable arrangement may alternatively be used to transmit the measurements of the gas properties to an external electronic device, such as bluetooth.

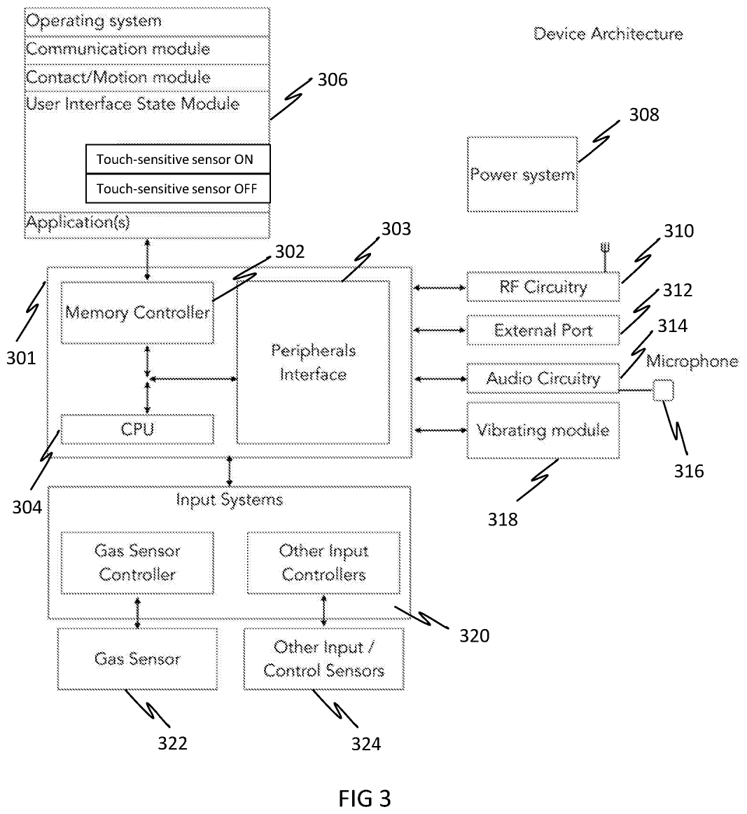

Referring to FIG. 3, the component architecture of the mask 100 is shown.

Block 301 shows a control system of the mask 100. The control system contains a memory controller 302, a peripherals interface 303 and a CPU 304. The memory controller 302, a peripherals interface 303 and a CPU 304 are all in communication with one another.

Block 306 is in communication with block 301. Block 306 contains an operating system, communication module, a contact/motion module and a user interface state module. Power system 308 provides an electrical source of power to the various components of the wearable mask 100.

The control system 301 is in communication with the RF modules 114. The Control system 301 is in communication with RF circuitry 310 so as to communicate with the RF modules 114. As noted above in connection with FIG. 1, the wearable mask 100 may communicate with an external electronic device via RF modules 114.

The control system 301 is in communication with an external port 312. The skilled person would appreciate that the wearable mask may also communicate with an external electronic device via external port 312, e.g. via a wired connection.

As discussed above, the mask 100 may include an indicator configured to indicate movement of the mask 100 from the locked state to the unlocked state. In the arrangement shown, the control system 301 is in communication with audio circuitry 314 and/or a vibrating module 318. The audio circuitry 314 is connected to a microphone 316 (i.e. an audio indicator). Thus, in the arrangement shown, the microphone 316 and/or vibrating module 318 acts as an indicator to indicate to a user that the wearable mask 100 is transitioning from a locked state to an unlocked state.

FIG. 3 shows input systems 320 (i.e. the sensor assembly) in communication with the control system 301. The sensor assembly includes a gas sensor 322 (i.e. the first sensor). The sensor assembly includes a gas sensor controller in communication with a gas sensor 322. 12. The sensor assembly is configured to activate the first sensor 322 (i.e. via the gas sensor controller) to monitor the gas properties periodically, for example every minute. This has been found to effectively reduce energy usage of the mask 100. The sensor assembly 320 may also contain other input control sensors 324 such as the second (movement) sensor and third (temperature) sensor.

Three types of data are being measured simultaneously by the mask 100, these are: gas concentration/composition via the first (gas) sensor 322; gas humidity via the first (gas) sensor 322; and temperature via the third (temperature) sensor.

Realtime measurements are taken by the mask every minute. Each measurement is recorded for a pre-determined length of time, for example for continuous intervals in the range 5 to 10 seconds. The mask 100 may configured to detect the concentration of one or more of methane, carbon monoxide, iso-butane, hydrogen and/or ethanol in a gas (i.e. in a user's breath and/or in ambient air).

The data is stored on internal memory controller 302. The data stored on the memory 302 is pushed to an external electronic device via a syncing. Transmission of the data in this way has been found to reduce energy consumption of the mask 100, thus extending the battery life.

The synced data/information is uploaded/transmitted to the external electronic device through an encrypted channel. The external electronic device may then analyse the data via a machine learning algorithm including a neural network. The neural network may perform pattern recognition on the data to identify any potential harmful scenarios (e.g. to detect is the ambient air may be potentially harmful to a user and/or to alert as user to any potential health issues) of the user, and to alert the user via the mask 100.

Keton levels can be measured in expiratory gases (i.e. the breath) of a user. The mask is configured to measure these keton levels in the expiratory gas. Keton levels are generally between 0.5 and 3.0 millimomar (mM) in physiologic ketosis. In ketoacidosis, however, keton levels in expiratory gases (i.e. the breath) of a user may be present in concentrations greater than 10 mM. During metabolism, some acetyl-CoA molecules can be converted into keton bodies: acetoacetate, beta-hydroxybuterate, and acetone, which can function as signalling molecules. Put another way, the mask 100 may configured to detect concentration in a user's breath of one or more of acetoacetate, beta-hydroxybuterate, and/or acetone, which can signal that ketosis is occurring. Ketosis is being investigated for a growing number of conditions and can be a signal in, but not limited to: Neurological diseases such as epilepsy, Alzheimer's disease, amyotrophic lateral sclerosis, autism, migraine headache, neurotrauma, pain, Parkinson's disease, and sleep disorders; Cancer as ketosis may have anti-tumor effects; Glycogenosis; and other conditions such as type 1 diabetes, non-alcoholic fatty liver diseases, acne, polycystic kidney disease and polycystic ovary syndrome.

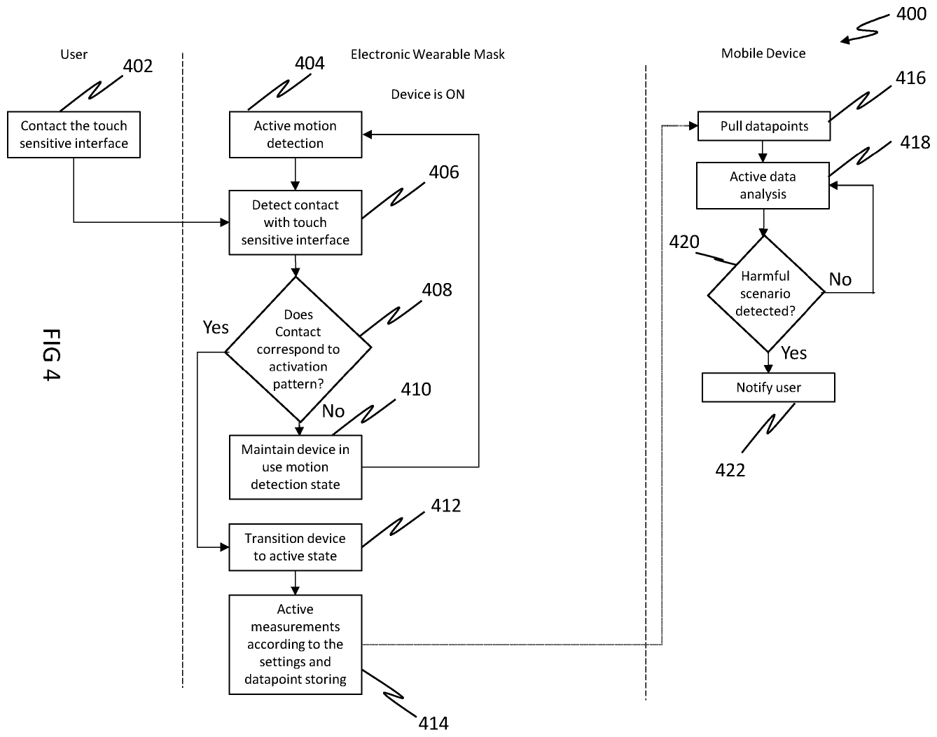

Referring to FIG. 4, a control logic for moving the mask 100 from a locked state to an unlocked state is shown.

At step 402 the user contacts the touch sensitive interface of the wearable mask. When the wearable mask is switched on and in an active motion detection mode (step 404), the wearable mask detects user contact with the touch sensitive interface (step 406). Put another way, when movement of the mask is detected (step 404), the wearable mask is able to detect user contact with the touch sensitive interface (step 406). In this way, mask 100 (i.e. the control system) is configured to move from the locked state to the unlocked state only when movement of the mask is detected.

The control system is configured to move the mask from the locked state to the unlocked state only when the user input corresponds to an activation pattern. In the arrangement shown, the user interface is a touch-sensitive user interface and the pre-defined activation pattern may be a double-tap on the touch-sensitive user interface. The control system is configured to prevent movement from the locked state to the unlocked state upon a determination that the input does not correspond to the activation pattern.

At step 408, a determination is made whether the contact corresponds to an activation pattern. The pre-determined pattern may be stored in the memory of the mask 100. If the contact does not correspond to the activation pattern, then the wearable mask reverts to step 404 (active motion detection). However, if the contact does correspond to the activation pattern, then the wearable mask proceeds to step 412, in which the wearable mask transitions from the locked state into the unlocked state. Following movement into the unlocked state the wearable mask 100 begins monitoring a quality of the gas and storing gas quality (i.e. gas composition and/or humidity) data measurements in its memory (step 414).

At step 416, the wearable device transmits the stored gas quality data measurements to an external electronic device, such as a mobile device. Preferably, the wearable device transmits the stored gas quality data measurements to the external electronic device via a syncing process in order to preserve battery level of the wearable device. The mobile device actively analyses the data (step 418) in order to detect a scenario that may be harmful to the user of the wearable mask (step 420). If a harmful scenario is detected, the mobile device notifies the user (step 422). If no harmful scenario is detected, the mobile device reverts to step 418.

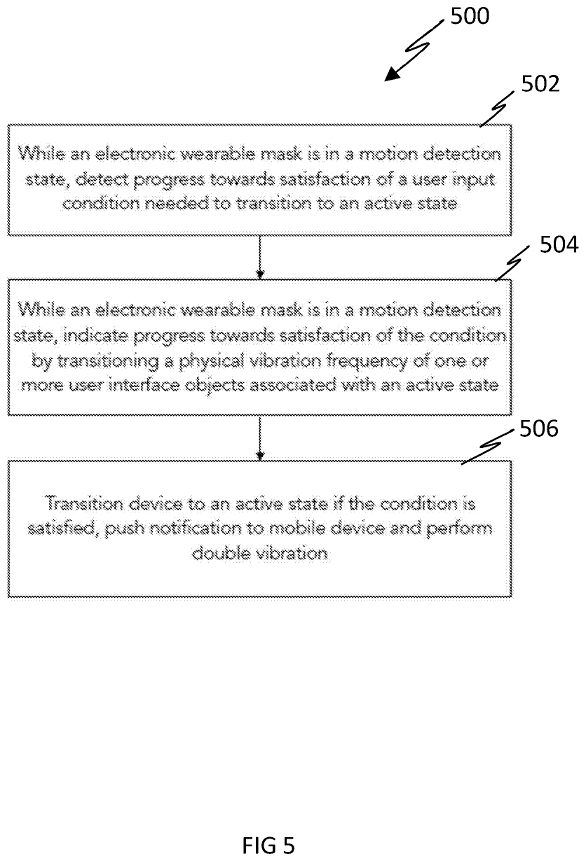

Referring to FIG. 5, a flowchart 500 illustrating a transition of the wearable device from a locked state to an unlocked state is shown.

At step 502, while the wearable mask is in a motion detection state (i.e. a locked state) the wearable mask detects progress towards satisfaction of a user input condition needed to transition to an active state (i.e. an unlocked state). As mentioned above in connection with FIG. 1, the user input condition may be a touch input on a touch sensitive user interface of the wearable mask. While the wearable mask is in the motion detection condition, the electronic device may indicate progress towards satisfaction of the user input condition (step 504) by transitioning a vibration frequency of one or more user interface objects associated with the active state (e.g. by activating vibration module 318 as discussed above in connection with FIG. 3). If the motion detection condition is satisfied, the wearable mask transitions to an active state and notifies a mobile device external to the wearable mask, and performs a double vibration (step 506).

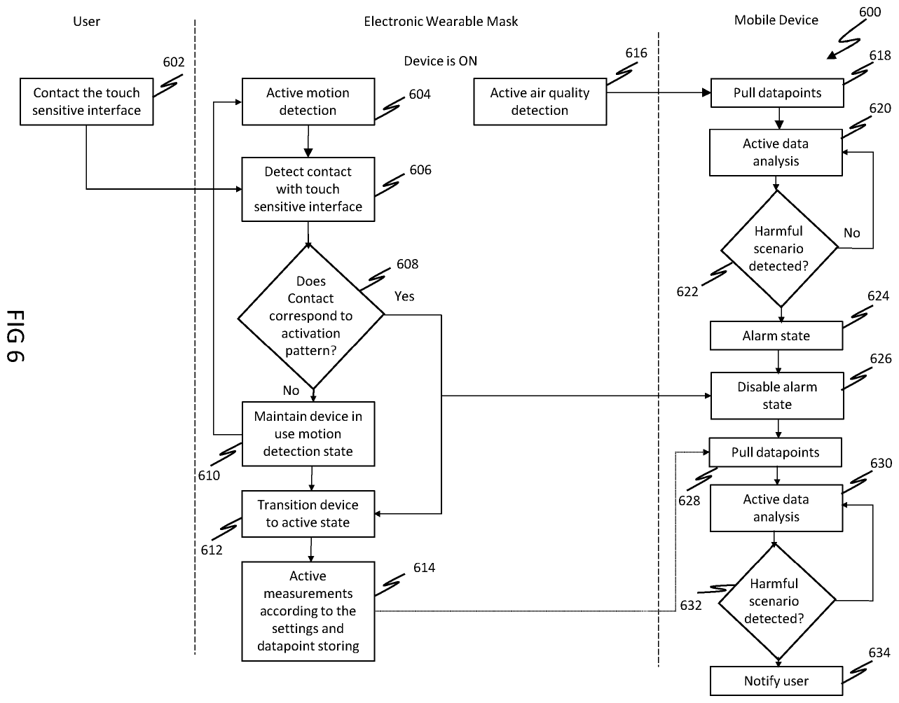

Referring to FIG. 6, a control logic for moving the mask 100 from a locked state to an unlocked state is shown.

At step 602 the user contacts the touch sensitive interface of the wearable mask. When the wearable mask is switched on and in an active motion detection mode (step 604), the wearable mask detects user contact with the touch sensitive interface (step 606).

At step 608, a determination is made whether the contact corresponds to an activation pattern. If the contact does not correspond to the activation pattern, then the wearable mask reverts to step 604 (active motion detection). However, if the contact does correspond to the activation pattern, then the wearable mask proceeds to step 612, in which the wearable mask transitions from the locked state into the unlocked state, following which the wearable mask begins monitoring a quality of the gas and storing gas quality data measurements in its memory (step 614).

The wearable mask may communicate stored gas quality data measurements with an external electronic device, such as a mobile device, in different ways. In a first method of operation, the wearable mask is in state where it actively detects properties of the gas (step 616). The mobile device may pull datapoints related to the properties of the gas as recorded by the mask 100 directly from the mask 100 (step 618). At step 620, the mobile device analyses the datapoints via a machine learning algorithm including a neural network. The neural network may perform pattern recognition on the data to identify any potential health issues (i.e. an illness or disease) of the user. If a harmful scenario is detected (step 622), the external electronic device alerts the user via the mask 100. The external electronic (e.g. mobile) device proceeds to step 624 and transitions the mask 100 into an alarm state. The alarm state may be disabled upon determination that a further user contact on the wearable mask corresponds to the activation pattern. The external electronic device then proceeds to step 630 where the mobile device continues to analyse data received from the wearable device. If a harmful scenario is detected (step 632), the device notifies the user (step 634). If no harmful scenario is detected, the mobile device reverts to the data analysis of step 630.

In a second method of operation, the mobile device receives, at step 628, gas properties data measurements stored by the wearable mask at step 614. The device then proceeds as above to step 630 where the device continues to analyse data received from the mask 100. If a harmful scenario is detected (step 632), the mobile device notifies the user (step 634), otherwise the mobile device reverts to step 630.

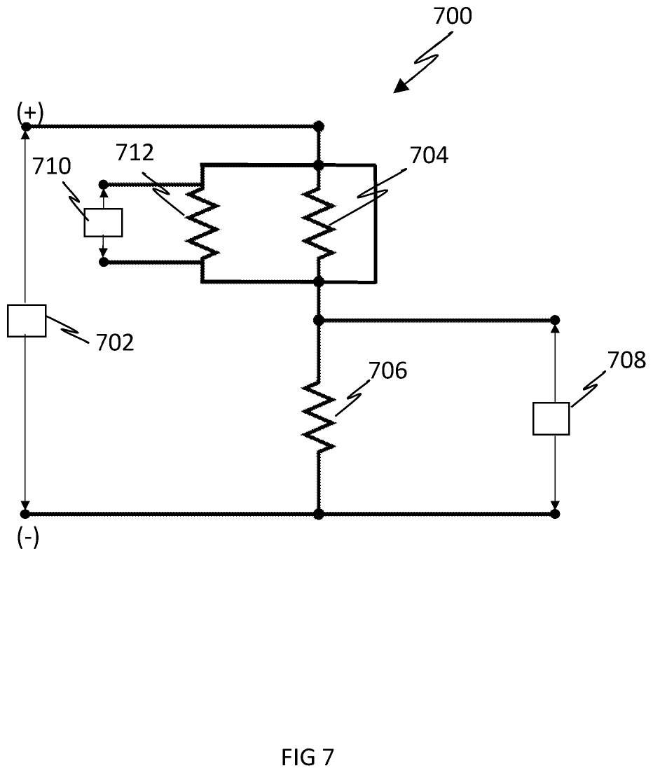

Referring now to FIG. 7, a measuring circuit 700 of the mask 100 is shown. The measuring circuit 700 is configured to measure a quality (e.g. composition and/or humidity) of gas. It will be appreciated that the measuring circuit 700 may be part of the first (gas) sensor discussed above. The measuring circuit 700 comprises circuit voltage supply 702, sensing element resistance 704, load resistance 706 in series with sensing element resistance 704, voltage sensor 708, heater voltage supply 710 and heater resistance 712. The properties of the gas are determined based on a resistance of the sensing element 704.

The circuit voltage supply 702 is used to power the measuring circuit 700. It will be appreciated that the circuit voltage supply 702 may be the same as the electrical source of power previously discussed, or may be separate therefrom. The sensing element resistance 704 is exposed air in proximity to the wearable mask to determine a quality of gas in open air or a user's breath (i.e. a user's expiratory gases). The load resistance 706 is used as part of a potential divider to measure the resistance of the sensing element resistance 704. Voltage sensor 708 measure the voltage drop across the load resister 706.

The sensing element resistance 704 fluctuates when exposed to different gases and different concentrations of said gases. Therefore, by determining the resistance of the sensing element resistance 704, a concentration of gas can be measured. The resistance of the sensing element can be calculated using the following equation:

$${R}_{S} = ( \frac{{V}_{s}}{V} - 1 ) {R}_{L}$$

Where:
Rₛ is the sensing element resistance 704
Vₛ is the circuit voltage supply 702
V is the voltage measured at voltage sensor 708
R_{L} is the load resistance 706. The load resistance 706 is of a predetermined value.

The measured sensing element resistance 704 could be used to determine the concentration of various gases the wearable mask is exposed to by using a gas concentration sensitivity characteristics of the sensing element resistance 704. The humidity can also be measured using the humidity dependency characteristics of the sensing element resistance 704. The measuring circuit may also comprise a temperature sensor for sensing the ambient temperature.

Heater voltage supply 710 applies voltage to an integrated heater. The heater maintains the sensing element at a specific predetermined temperature that is optimal for sensing. It will be appreciated that the heater voltage supply 710 may be the same as the electrical source of power previously discussed, or may be separate therefrom.

Although the teachings have been described above with reference to one or more preferred embodiments, it will be appreciated that various changes or modifications may be made without departing from the scope as defined in the appended claims.

1. A mask for wearing over a face of a user, the mask comprising:
a mask body;
a filter connected to the mask body;
an electrical power source;
a control system;
a user interface in communication with the control system; and
a sensor assembly comprising a first sensor,
wherein the first sensor is configured to measure properties of a gas, e.g. ambient air and/or expiratory gases of a user, and to provide an output to the control system based on the measured gas properties.

2. The mask according to claim 1, comprising a locked state in which the first sensor is inactive and an unlocked state in which the first sensor is active so as to measure properties of a gas.

3. The mask according to claim 2, wherein the control system is configured to move the mask from the locked state to the unlocked state based upon a user input detected by the user interface.

4. The mask according to claim 3, wherein the control system is configured to move the mask from the locked state to the unlocked state only when the user input corresponds to an activation pattern.

5. The mask according to claim 4, wherein the user interface is a touch-sensitive user interface and the pre-defined activation pattern is a double-tap on the touch-sensitive user interface.

6. The mask according to claim 2, wherein the sensor assembly comprises a second sensor configured to detect movement of the mask, and wherein the control system is configured to move from the locked state to the unlocked state only when movement of the mask is detected.

7. The mask according to claim 2, comprising an indicator configured to indicate movement of the mask from the locked state to the unlocked state.

8. The mask according to claim 1, comprising a memory, wherein the output of the first sensor, corresponding to measured gas properties, is stored in the memory.

9. The mask according to claim 8, configured to transmit, e.g. via wired or wireless connection, the measured gas properties stored in the memory to an external electronic device for analysis.

10. The mask according to claim 9, comprising an indicator configured to be activated based on a signal received from an external electronic device, e.g. via an RF module, for notifying the user of a harmful scenario detected by the external electronic device.

11. (canceled)

12. The mask according to claim 1, wherein the first sensor is configured to measure the composition of the gas and/or the humidity of the gas.

13. The mask according to claim 1, wherein the sensor assembly is configured to measure the gas properties periodically and/or for a pre-determined length of time.

14. (canceled)

15. The mask according to claim 1, configured to measure gas concentration/composition via the first sensor; gas humidity via the first sensor; and temperature via a temperature sensor.

16. The mask according to claim 1, configured to detect concentrations of one or more of: acetoacetate; beta-hydroxybuterate; acetone; methane; carbon monoxide; iso-butane; hydrogen and/or ethanol in the gas.

17. The mask according to claim 1, wherein the first sensor is configured to measure the properties of the gas for detecting keton levels in the expiratory gases of a user.

18. The mask according to claim 1, wherein the sensor assembly comprises a measuring circuit comprising a sensing element and a load resistor of a predetermined resistance in series with the sensing element, and wherein the properties of the gas are determined based on a resistance of the sensing element.

19. The mask according to claim 1, wherein the sensor assembly comprises a third sensor configured to determine ambient temperature.

20. The mask according to claim 1, comprising a heater configured to heat the first sensor to a predetermined temperature.

21. A system comprising:
a mask according to claim 1; and
an electronic device,
wherein the mask is configured to generate a sensor output signal to the control system in response to measured gas properties and to store data corresponding to the measured gas properties in a memory of the mask,
wherein the mask is configured to transmit the data to the external electronic device, and
wherein the external electronic device is configured to analyse the data using a machine learning algorithm to determine if there is a harmful scenario.

22. The system according to claim 20, wherein the mask comprises an indicator configured to be activated based on an output signal received from the external electronic device. when a harmful scenario has been determined by the external electronic device.
